(19) United States
(12) Patent Application Publication
(10) Pub. No.: US 2026/0027797 A1
(43) Pub. Date: Jan. 29, 2026

(54) RADIAL PRESS

(71) Applicant: Uniflex-Hydraulik GmbH, Karben (DE)

(72) Inventors: Heidi JARRASCH, Rossbach (DE); Carsten BAUMGARTNER, Laubach (DE)

(73) Assignee: Uniflex-Hydraulik GmbH, Karben (DE)

(21) Appl. No.: 19/349,501

(22) Filed: Oct. 3, 2025

Related U.S. Application Data
(63) Continuation of application No. PCT/EP2024/059053, filed on Apr. 3, 2024.

(30) Foreign Application Priority Data
Apr. 20, 2023 (DE) 10 2023 109 974.4

(51) Int. Cl. B30B 11/00; B30B 11/02

(52) U.S. Cl. CPC B30B 11/007; B30B 11/027

(57) ABSTRACT

A radial press has a frame structure, a press tool received by the frame structure, and a drive unit. The press tool has at least four base jaws arranged about a press axis and which can be moved radially relative to the press axis in a synchronized way by the drive unit to open or close the press tool, and to which a corresponding press jaw head is replaceably attached and has a press surface for acting on a workpiece arranged in the region of the press axis. Each press jaw head is a composite component and has a longitudinal structure extending along the press axis and multiple lamellas stacked one on top of the other in the direction of the press axis and connected together by the longitudinal structure in order to form a block. The lamellas are replaceably attached to the longitudinal structure in a form-fitting manner.

### CROSS REFERENCE TO RELATED APPLICATIONS

This application is a continuation under 35 U.S.C. § 120 of International Application PCT/EP2024/059053, filed Apr. 3, 2024, which claims priority to German Application No. 10 2023 109 974.4, filed Apr. 20, 2023, the contents of each of which are incorporated by reference herein.

### FIELD OF THE INVENTION

The present invention relates to a radial press with a frame structure, a press tool accommodated therein and a drive unit, wherein the press tool comprises at least four base jaws which are arranged around a press axis and which, for closing or opening the press tool, can be moved synchronously radially towards or away from the press axis by means of the drive unit and to each of which a press jaw head with a pressing surface intended for acting on a workpiece to be arranged in the region of the press axis is replaceably mounted.

### BACKGROUND

Radial presses, which are suitable for radial pressing of various types (e.g. the permanent attachment of connection fittings at the end of a hose piece for the production of a hydraulic hose line), are known in various designs (e.g. hollow piston press, pressure plate press and yoke press) and various configurations. Reference should be made, for example, to DE 20 2016 100 660 U1, DE 20 2016 008 097 U1, DE 10 2016 106 650 A1, DE 10 2014 014 585 B3, DE 10 2014 012 485 B3, DE 10 2014 008 613 A1, DE 10 2011 015 770 A1, DE 10 2011 015 654 A1, DE 10 2009 057 726 A1, DE 10 2005 041 487 A1, DE 10 2005 034 260 B3, DE 601 21 915 T2, DE 298 24 688 U1, DE 199 44 141 C1, DE 199 40 744 B4, DE 101 49 924 A1, DE 41 35 465 A1 and DE 35 13 129 A1.

Irrespective of their respective design and other technical features, the known radial presses often coincide in that a plurality of base jaws—most commonly eight base jaws—arranged evenly distributed around the press axis and approximately wedge-shaped in cross-section are moved evenly radially in the direction of the press axis by means of a (typically hydraulic) drive.

Press jaw heads, which have a pressing surface adapted to the geometry (in particular the diameter) of the workpiece to be pressed, can often be replaceably mounted or attached radially on the inside of the base jaws.

So-called profiled press jaw heads are used in particular if the cross-section of the workpiece changes along the press axis and/or the press jaw heads are to be designed in such a way that the workpiece is supported on the press jaw heads (or strikes against them) during pressing for better positioning in the direction of the press axis. A profiled press jaw head does not have a continuous, partially cylindrical or flat pressing surface over its entire axial extension. Instead, the (profiled) pressing surface of a profiled press jaw head is made up of several separate pressing surface segments (partial pressing surfaces), which can be partially cylindrical or flat. Profiled press jaw heads are expensive and time-consuming to manufacture due to the complex design of the profiled pressing surface.

Each workpiece requires press jaw heads that are matched to the respective workpiece. With profiled press jaw heads in particular, it is common that they can only be used in conjunction with a single, special workpiece.

Before another workpiece can be pressed, a new set of appropriately adapted profiled press jaw heads must therefore generally be provided, which is usually associated with waiting times for their production.

The user of a radial press must therefore keep a large number of different press jaw heads in stock in order to be able to press different workpieces. This results in high investment costs for the purchase of the various press jaw heads and a large amount of space required for their storage.

There is a need for a radial press of the type described at the beginning, which is characterized by a higher degree of practical suitability, in particular with regard to the easier and faster adaptability of the radial press (in particular the press jaw heads) to the workpiece to be pressed, a lower investment cost and a smaller space requirement.

### SUMMARY

A radial press is described with a frame structure, a press tool accommodated therein and a drive unit, wherein the press tool comprises at least four base jaws which are arranged around a press axis and which, for closing or opening the press tool, can be moved synchronously radially towards or away from the press axis by means of the drive unit and to each of which a press jaw head with a pressing surface intended for acting on a workpiece to be arranged in the region of the press axis is replaceably mounted, with the following features:
the press jaw heads are each designed as a composite component and each comprise a longitudinal structure extending along the press axis and a plurality of lamellae layered on top of one another in the direction of the press axis and connected to one another by means of the longitudinal structure to form a block,
the lamellae are replaceably mounted (fastened) to the longitudinal structure and engage with it in a form-fit manner perpendicular to the press axis.

The inventors have recognized that a unique combination of advantages can be achieved in the synergetic interaction of the features described herein.

On the one hand, the realization of the press jaw heads as composite parts made of layered lamellae enables their particularly cost-effective manufacture. This is because, in this way, the press jaw heads can be constructed from a number of individual parts that can be manufactured very cheaply, e.g. from punched-out lamellae—and do not have to be made in one piece in a complex and expensive process, e.g. by forging, casting or milling them from solid material, as is usually the case. This makes it easier and cheaper to manufacture the press jaw heads, which reduces the investment costs of the radial press.

On the other hand, the lamellar structure of the press jaw heads allows the contour of the pressing surface to be easily and individually adapted to the workpiece to be pressed. Thus, profiled press jaw heads in particular can be realized very easily if, for example, the cross-section of the workpiece changes along the press axis, the axial extension of the workpiece changes and/or the press jaw heads are to be designed in such a way that the workpiece is supported on the press jaw heads (or on a lamella of the respective press jaw head) during pressing for better positioning in the direction of the press axis or strikes there. Such profiled press jaw heads can be provided by stacking lamellae with different radial expansions on top of each other to form a block.

And because the lamellae are replaceably mounted (fastened) to the longitudinal structure, the user of the radial press can adapt the profiling of the press jaw heads to the workpiece to be pressed independently, easily, quickly and without having to use machining production processes. All the user has to do is adjust the sequence of the lamellae stacked on top of each other or replace selected lamellae with lamellae with a different radial expansion.

In this way, profiled press jaw heads adapted to the respective workpiece can be provided quickly, easily and as required, saving investment costs, storage space and time.

In the following, selected features of the radial press and terms used in this context will be discussed in more detail.

The formulation that the lamellae are replaceably mounted or mountable to the longitudinal structure expresses that the lamellae can be removed from the longitudinal structure as intended without the need to use cutting processes for this purpose.

The term that the lamellae engage with the longitudinal structure perpendicular to the press axis (i.e. in a radial direction with respect to the press axis) expresses that a positive fit between the respective lamellae and the longitudinal structure prevents them from moving against each other in a radial direction. Such a positive fit can be realized, for example, by interlocking the longitudinal structure on the one hand and the lamellae on the other, thus preventing them from moving relative to each other in the radial direction.

The longitudinal structure extends along the press axis, connects the lamellae stacked on top of one another in the direction of the press axis to form a block and can be positively connected to the lamellae perpendicular to the press axis. This implies that the longitudinal structure extends along the lamellae.

According to a first preferred embodiment of the radial press, the longitudinal structures of the press jaw heads each comprise a base structure extending along the press axis, which is replaceably mounted (fastened) to one of the base jaws and (in the mounted, fastened state) is in contact with the base jaw.

In this way, a radial press can be realized in which the press jaw heads can be quickly and easily attached to and removed from the base jaws. In particular, if fastening means are provided on the base structures of the press jaws heads, which correspond to corresponding receiving means on the base jaws and ensure that the press jaw heads are fixed and positioned.

It is particularly preferable for the lamellae each engage with the base structure in a form-fit manner perpendicular to the press axis by means of a dovetail connection.

In a dovetail connection, a (cross-sectionally) trapezoidal tongue (tine) of a first component engages in a corresponding trapezoidal groove (recess) of a second component in order to positively connect the two components in the trapezoidal plane.

In this context, tongue-and-groove connections in which the tongue or the tongue (in cross-section) is not exactly trapezoidal but, for example, fir-tree-shaped, circular or semi-circular, are also regarded as dovetail connections in the present sense, as long as they enable a positive connection between two components in the cross-sectional plane.

It is irrelevant whether the tongue is arranged on the lamella side or the base structure side.

In this way, press jaw heads can be realized according to this disclosure, in which the lamellae can be positively connected to the base structure in a particularly simple, reliable and stable manner. A lamella can be removed from the base structure by “unthreading” the tongue (or the groove) of the respective lamella from the corresponding groove (or the tongue) of the base structure in the direction of the press axis.

According to another equally preferred embodiment, it may be provided that
the longitudinal structures of the press jaw heads are each designed as a carrier bar extending along the press axis,
the lamellae are pushed (“threaded”) onto the carrier bar through openings corresponding to the carrier bar and in this way engage with the carrier bar in a form-fit manner perpendicular to the press axis.

The carrier bar and the corresponding openings can have a rectangular, polygonal, round or oval cross-section.

It is also preferable for the press jaw heads to each have a profiled pressing surface which is not continuous over its entire axial extent and is designed to be partially cylindrical or flat.

As already explained above, the advantages according to the disclosure manifest themselves to a very particular extent with such profiled press jaw heads.

The pressing surfaces are preferably each composed of a plurality of pressing surface segments formed on different lamellae.

The lamellae differ in particular in their radial extent, so that they have pressing surface segments that are spaced at different distances from the press axis.

According to a further preferred embodiment, the pressing surface segments are spaced apart from one another in that lamellae without pressing surface segments (spacer lamellae) are accommodated between the lamellae having pressing surface segments (pressing lamellae).

The spacer lamellae therefore have a greater distance to the press axis than the pressing lamellae and do not come into contact with the workpiece to be pressed during pressing. This means that the spacer lamellae do not have a pressing surface segment.

According to a further advantageous embodiment, it can be provided that lamellae of a press jaw head consist of different materials.

In this way, the pressing properties can be optimized for specific lamellae and/or particularly cost-effective press jaw heads can be provided. For example, by manufacturing only the press lamellae from a high-quality material with particularly good pressing properties, while the spacer lamellae, which are not stressed in the radial direction (to the press axis) by the pressing, are made from a less expensive material.

Furthermore, according to a further advantageous embodiment, it can be provided that:
the press jaw heads have at least two clamping elements arranged at different ends of the longitudinal structure, and
in particular one of the clamping elements is designed as a screw element.

In this way, the lamellae can be fixed in the axial direction (with respect to the press axis) in a particularly simple and effective manner. Undesired “tilting” of the lamellae from their perpendicular position (with respect to the press axis) during pressing can thus be prevented.

Also provided is a press jaw head which is adapted for use in a radial press according to the disclosure.

### BRIEF DESCRIPTION OF THE DRAWING

In the following, several embodiments of the invention are explained in more detail with reference to the drawing.

FIG. 1 shows a rough schematic representation of a radial press according to the invention.

FIGS. 2A & 2B show a first example of a press jaw head of a radial press according to the invention in a lateral and a frontal sectional view.

FIGS. 3A & 3B show a second embodiment example of a press jaw head of a radial press according to the invention in a lateral and a frontal sectional view.

### DETAILED DESCRIPTION OF THE PREFERRED EMBODIMENTS

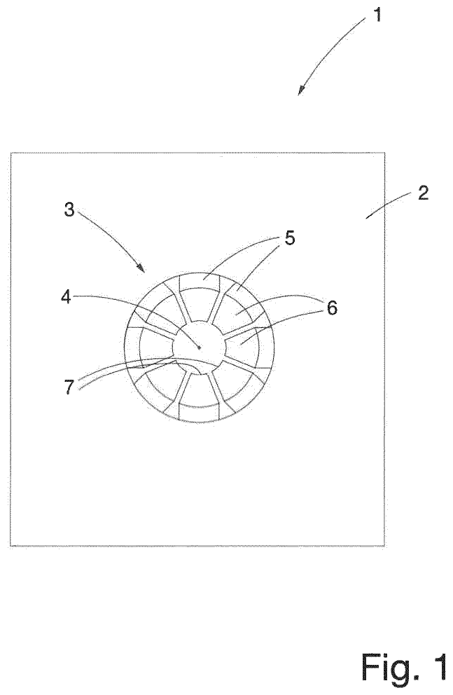

FIG. 1 shows a rough schematic representation of a radial press 1 according to the invention. The radial press 1 has a frame structure 2, a press tool 3 accommodated therein and a drive unit. The press tool 3 comprises eight base jaws 5 arranged around a press axis 4. The base jaws 5 can be moved synchronously radially towards or away from the press axis 4 by means of the drive unit in order to close or open the press tool 3. A press jaw head 6 is replaceably mounted (fastened) to each base jaw 5. The press jaw heads 6 each have a pressing surface 7, which is intended to act on a workpiece (not shown in the drawing) to be arranged in the area of the press axis 4.

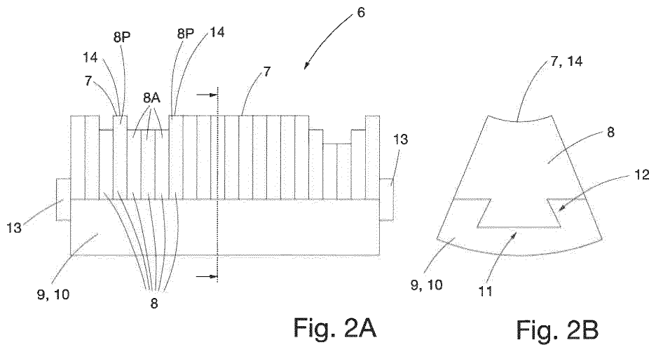

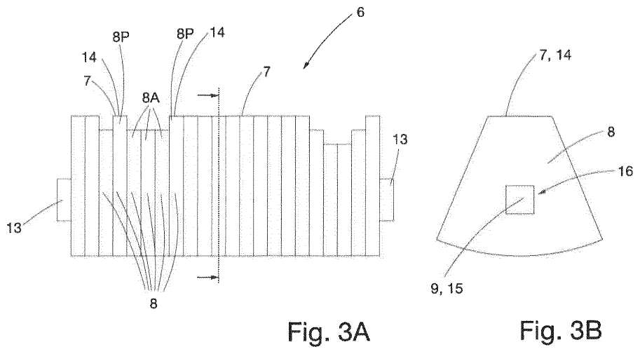

With reference to FIGS. 2A to 3B, the structure of two embodiments of a press jaw head 6 of a radial press 1 according to the invention will be explained in more detail.

The press jaw heads 6 are each designed as a composite component. They comprise a plurality of lamellae 8, which are connected to form a block by means of a longitudinal structure 9. The lamellae 8 are stacked on top of each other in the direction of the press axis 4. The longitudinal structure 9 extends along (i.e. longitudinally) the press axis 4.

In the first embodiment example of a press jaw head 6 shown in FIGS. 2A and 2B, the longitudinal structure 9 comprises a base structure 10 extending along the press axis 4, which can be replaceably attached (fastened) to one of the base jaws 5 and is in contact with it in the attached state. The base structure 10 has a trapezoidal groove 11, which engages in corresponding trapezoidal tongues 12 of the lamellae 8. The dovetail joint formed in this way (by groove and tongue) connects the lamellae 8 to the base structure 10 in a form-fit manner in a direction perpendicular to the press axis 4 (i.e. in a radial direction to the press axis 4).

A clamping element 13 designed as a screw element is arranged at opposite ends of the base structure 10. The lamellae 8 can be clamped by means of the clamping elements 13 surrounding the lamellae 8 and thus fixed in their position in the direction of the press axis 4. If at least one of the screw elements is loosened and removed, the lamellae 8 can be removed from the base structure 10 and thus the lamellae 8 can be replaced. To do this, the tongue 12 of the lamellae 8 must be removed (i.e. pulled or pushed) from the corresponding groove 11 along the press axis 4.

The press jaw head 6 shown in FIGS. 2A and 2B has a profiled pressing surface 7, which is composed of several partially cylindrical pressing surface segments 14 formed on different lamellae 8. This means that the pressing surface 7 is not designed to be partially cylindrical over its entire axial extent. Between some lamellae 8 with pressing surface segments 14, the so-called pressing lamellae 8P, lamellae without pressing surface segments, so-called spacer lamellae 8A, are arranged. The spacer lamellae 8A have a smaller radial extension (in the direction of the press axis 4) than the press lamellae 8P.

The second embodiment example of a press jaw head 6 shown in FIGS. 3A and 3B differs from the first embodiment example in the design of the longitudinal structure 9 and the pressing surface 7.

The longitudinal structure 9 is designed here as a carrier bar 15 with a rectangular cross-section extending along the press axis 4. The lamellae 8 have rectangular openings 16 corresponding to the carrier bar 16, through which the lamellae 8 are “threaded” onto the carrier bar 15. In this way, the lamellae 8 engage with the carrier bar 15 in a form-fit manner in the direction perpendicular to the press axis 4.

A clamping element 13 designed as a screw element is arranged at opposite ends of the carrier bar 15. The lamellae 8 can be clamped by means of the screw elements surrounding the lamellae 8 and thus fixed in their position in the direction of the press axis 4. If at least one of the screw elements is loosened and removed, the lamellae 8 can be removed from the carrier bar 15 and thus the lamellae 8 can be replaced.

The press jaw head 6 shown in FIGS. 3A and 3B also has a profiled pressing surface 7. However, the pressing surface 7 is made up of several flat pressing surface segments 14 formed on different lamellae 8. The pressing surface is therefore not continuously flat over its entire axial extension.

List of reference symbols

| | |
|---|---|
| Radial press | 1 |
| Frame structure | 2 |
| Press tool | 3 |
| Press axis | 4 |
| Base jaw | 5 |
| Press jaw head | 6 |
| Pressing surface | 7 |
| Lamella | 8 |
| Spacer lamella | 8A |
| Pressing lamella | 8P |
| Longitudinal structure | 9 |
| Base structure | 10 |
| Groove | 11 |
| Tongue | 12 |
| Clamping element | 13 |
| Pressing surface segments | 14 |
| Carrier bar | 15 |
| Opening | 16 |

What is claimed is:

1. A radial press with a frame structure, a press tool accommodated therein and a drive unit, wherein the press tool comprises at least four base jaws which are arranged around a press axis and which, for closing or opening the press tool, can be moved synchronously radially towards or away from the press axis by means of the drive unit and to each of which a press jaw head with a pressing surface intended for acting on a workpiece to be arranged in the region of the press axis is replaceably mounted, with the following features:
the press jaw heads are each designed as a composite component and each comprise a longitudinal structure extending along the press axis and a plurality of lamellae layered on top of one another in the direction of the press axis and connected to one another by means of the longitudinal structure to form a block,
the lamellae are replaceably mounted to the longitudinal structure and engage with it in a form-fit manner perpendicular to the press axis.

2. The radial press of claim 1, wherein the longitudinal structures of the press jaw heads each comprise a base structure extending along the press axis, which is replaceably mounted to one of the base jaws and is in contact with the base jaw.

3. The radial press of claim 2, wherein the lamellae each engage with the base structure in a form-fit manner perpendicular to the press axis by means of a dovetail connection.

4. The radial press of claim 1, wherein:
the longitudinal structures of the press jaw heads are each designed as a carrier bar extending along the press axis, and
the lamellae are pushed onto the carrier bar through openings corresponding to the carrier bar and in this way engage with the carrier bar in a form-fit manner perpendicular to the press axis.

5. The radial press of claim 1, wherein the press jaw heads each have a profiled pressing surface which is not continuous over its entire axial extent and is designed to be partially cylindrical or flat.

6. The radial press of claim 1, wherein the pressing surfaces are each composed of a plurality of pressing surface segments formed on different lamellae.

7. The radial press of claim 6, wherein the pressing surface segments are spaced apart from one another in that spacer lamellae without pressing surface segments are accommodated between pressing lamellae having pressing surface segments.

8. The radial press of claim 1, wherein lamellae of a press jaw head consist of different materials.

9. The radial press of claim 1, wherein:
the press jaw heads have at least two clamping elements arranged at different ends of the longitudinal structure, and
in particular one of the clamping elements is designed as a screw element.

10. A press jaw head configured for use in the radial press of claim 1.
